(19) United States
(12) Patent Application Publication
(10) Pub. No.: US 2020/0256955 A1
(43) Pub. Date: Aug. 13, 2020

(54) SYSTEM AND METHOD FOR ADAPTIVE ILLUMINATION IN A LIDAR SYSTEM

(71) Applicant: Analog Devices, Inc., Norwood, MA (US)

(72) Inventors: Ronald A. Kapusta, Carlisle, MA (US); Miles R. Bennett, Stanford, CA (US)

(21) Appl. No.: 16/270,075

(22) Filed: Feb. 7, 2019

(51) Int. Cl. G01S 7/484; G01S 7/487; G01S 7/486

(52) U.S. Cl. CPC G01S 7/484; G01S 7/4861; G01S 7/4876

(57) ABSTRACT

Techniques are described to adjust one or more parameters to vary the illumination output within at least one of the regions-of-interest (ROIs) in a field-of-view (FOV) and to adjust one or more corresponding receiver parameter(s). By associating different parameters between two or more ROIs within an FOV, this disclosure describes a LIDAR system having an adaptive FOV. An adaptive FOV can allow a LIDAR system to vary its performance between ROIs. For example, in an FOV having at least a first ROI and a second ROI, the LIDAR system can output more optical power in the first ROI then the second ROI to increase the signal-to-noise (SNR) ratio and therefore achieve a longer detection range.

### CROSS-REFERENCE TO RELATED PATENT DOCUMENTS

This patent application is also related to a U.S. patent application, filed even date herewith, titled OPTICAL PULSE CODING IN A LIDAR TRANSMITTER (Attorney Docket No. 3867.576US1; Client Docket No. APD 6667), naming Ronald A. Kapusta, Shaun S. Kuo, and Miles R. Bennett as inventors, the disclosure of which is hereby incorporated herein by reference, in its entirety, including its disclosure of generating a light pulse for transmission that has an optical intensity profile that includes a waveform having one or more relatively narrower pulses superimposed upon a relatively wider pulse.

### FIELD OF THE DISCLOSURE

This document pertains generally, but not by way of limitation, to systems for providing light detection and ranging (LIDAR).

### BACKGROUND

Light detection and ranging (LIDAR) systems, such as automotive LIDAR systems, may operate by transmitting one or more pulses of light towards a target region. The one or more transmitted light pulses can illuminate a portion of the target region. A portion of the one or more transmitted light pulses can be reflected and/or scattered by an object in the illuminated portion of the target region and received by the LIDAR system. The LIDAR system can then measure a time difference between the transmitted and received light pulses, such as to determine a distance between the LIDAR system and the illuminated object. The distance can be determined according to the expression d=tc/2, where d can represent a distance from the LIDAR system to the illuminated object, t can represent a round trip travel time, and c can represent a speed of light.

LIDAR systems generally include at least two functional blocks. The first block is the transmitter, which is responsible for generating and transmitting the illumination and all related functionality. The second block is the receiver, which is responsible for detecting the reflected illumination. Further functions, for example system control and signal processing can be split between the transmitter and receiver, contained fully within one of the two, or exist as separate blocks in the LIDAR system.

### SUMMARY OF THE DISCLOSURE

This disclosure is directed to, among other things, techniques to adjust one or more parameters to vary the illumination output within at least one of the regions-of-interest (ROIs) in a field-of-view (FOV) and to adjust one or more corresponding receiver parameter(s). By associating different parameters between two or more ROIs within an FOV, this disclosure describes a LIDAR system having an adaptive FOV. An adaptive FOV can allow a LIDAR system to vary its performance between ROIs. For example, in an FOV having at least a first ROI and a second ROI, the LIDAR system can output more optical power in the first ROI than the second ROI to increase the signal-to-noise (SNR) ratio in the first ROI and therefore achieve a longer detection range.

In some aspects, this disclosure is directed to a method for varying illumination between two or more regions-of-interest (ROI) within a field-of-view (FOV) using a light detection and ranging (LIDAR) system, the method comprising: transmitting a first light signal having a light signal parameter towards a first one of the ROIs; modifying the light signal parameter; transmitting a second light signal having the modified light signal parameter towards a second one of the ROIs; and modifying a parameter in a receiver circuit of the system in response to modifying the light signal parameter.

In some aspects, this disclosure is directed to a light detection and ranging (LIDAR) system configured to vary illumination between two or more regions-of-interest (ROI) within a field-of-view (FOV), the system comprising: a transmitter circuit configured to transmit a first light signal having a light signal parameter towards a first one of the ROIs; a control circuit configured to modify the light signal parameter and control the transmitter circuit to transmit a second light signal having the modified light signal parameter towards a second one of the ROIs; and a receiver circuit configured to receive reflected light from the second one of the ROIs and modify a parameter in the receiver circuit in response to the modified light signal parameter.

In some aspects, this disclosure is directed to a light detection and ranging (LIDAR) system configured to vary illumination between two or more regions-of-interest (ROI) within a field-of-view (FOV), the system comprising: means for transmitting a first light signal having a light signal parameter towards a first one of the ROIs; means for modifying the light signal parameter; means for transmitting a second light signal having the modified light signal parameter towards a second one of the ROIs; and means for modifying a parameter in a receiver circuit of the system in response to modifying the light signal parameter.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is an example of a LIDAR system that can implement various techniques of this disclosure.

FIG. 2 is a conceptual diagram depicting an example of a field-of-view with multiple regions-of-interest.

FIG. 3 is a conceptual diagram depicting examples of various light pulse parameters that can be adjusted between regions-of-interest in a field-of-view using various techniques of this disclosure.

FIG. 4 illustrates an example of a system architecture and corresponding signal flow, such as for implementing a LIDAR system in accordance with various techniques of this disclosure.

FIG. 5 illustrates another example of a system architecture and corresponding signal flow, such as for implementing a LIDAR system in accordance with various techniques of this disclosure.

FIG. 6 illustrates another example of a system architecture and corresponding signal flow, such as for implementing a LIDAR system in accordance with various techniques of this disclosure.

### DETAILED DESCRIPTION

A light detection and ranging (LIDAR) system can have a field-of-view (FOV) that represents the area covered by the system. A region-of-interest (ROI) can be a smaller region that is a subset of the FOV. In some implementations, an ROI can be a predefined region, such as a region pointing forward toward the horizon in an automotive LIDAR application. In other implementations, an ROI can be dynamically generated. For example, the LIDAR system can detect an object and then the system can define an ROI for that detected object. Thus, for many applications, e.g., automotive, a LIDAR system can define two or more ROIs within an FOV.

In some example implementations, an ROI can be as large as the entire FOV. For example, a first ROI can include everything within the FOV and any other ROIs, e.g., a second ROI, a third ROI, etc., can be subsets.

In addition, ROIs can overlap one another either partially or completely. For example, two ROIs that are smaller than the entire FOV can be the same size and overlap completely. As an example, if a first ROI and a second ROI are the same size and overlap completely, the first ROI can be illuminated with a higher power pulse to detect targets far away and the second ROI can be illuminated with narrow pulses for good range resolution, which can desirable to use directly in front of a vehicle in the direction of travel. For each ROI, the LIDAR system can transmit light and receive a reflected signal. As such, each ROI impacts the optical budget of the LIDAR system, e.g., power, energy, and thermal load.

The present inventors have recognized a need to reduce the optical budget of the LIDAR system. The present inventor has recognized that by varying the illumination properties of the transmitter circuit of the LIDAR system between two or more ROIs within an FOV, the optical budget can be utilized more efficiently.

This disclosure is directed to, among other things, techniques to adjust one or more parameters to vary the illumination output within at least one of the ROIs in an FOV and to adjust one or more corresponding receiver parameter(s). By associating different parameters between two or more ROIs within an FOV, this disclosure describes a LIDAR system having an adaptive FOV. An adaptive FOV can allow a LIDAR system to vary its performance between ROIs. For example, in an FOV having at least a first ROI and a second ROI, the LIDAR system can output more optical power in the first ROI than the second ROI to increase the signal-to-noise (SNR) ratio in the first ROI and therefore achieve a longer detection range.

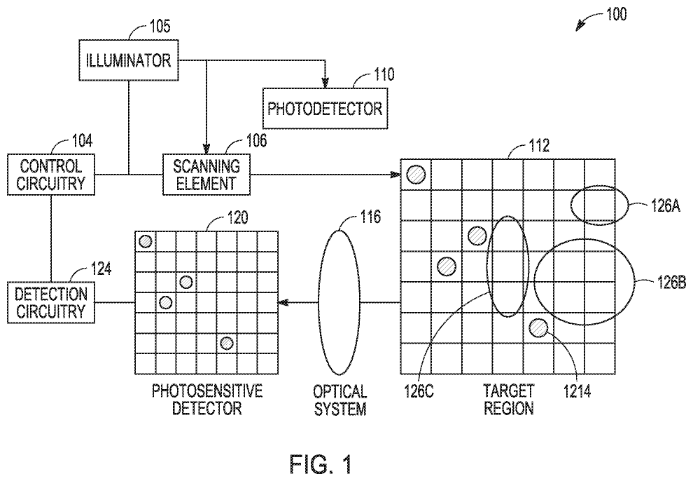

FIG. 1 shows an example of portions of a LIDAR system 100. The LIDAR system 100 can include control circuitry 104, an illuminator circuit 105, a scanning element 106, an optical system 116, a photosensitive detector 120, and detection circuitry 124. The control circuitry 104 can be connected to the illuminator circuit 105, the scanning element 106 and the detection circuitry 124. The photosensitive detector 120 can be connected to the detection circuitry 124.

During operation, the control circuitry 104 can provide instructions to the illuminator 105 and the scanning element 106, such as to cause the illuminator 105 to emit a light beam towards the scanning element 106 and to cause the scanning element 106 to direct the light beam towards the target region 112. In an example, the illuminator 105 can include a laser and the scanning element. The scanning element can adjust an angle of the light beam based on the received instructions from the control circuitry 104. The scanning element can be an electro-optic waveguide, a MEMS mirror, a mechanical mirror, an optical phased array, or any other optical scanning device. By using various techniques of this disclosure, an adaptive FOV can be achieved without having to use a vector scanner.

The target region 112 can correspond to a field-of-view (FOV) of the optical system 116. The scanning element can scan the light beam over the target region 112 in a series of scanned segments 114. The optical system 116 can receive at least a portion of the light beam from the target region 112 and can image the scanned segments 114 onto the photosensitive detector 120 (e.g., an array of avalanche photodiodes, single photon avalanche detectors, or p-i-n photodiodes; a CMOS sensor; or a charge-coupled device). The detection circuitry 124 can receive and process the image of the scanned points from the photosensitive detector 120, such as to form a frame.

In an example, the control circuitry 104 can select one or more regions-of-interest (ROIs) 126A-126C (referred to collectively in this disclosure as ROIs 126), where each ROI can be a subset of the FOV of the optical system and instruct the electro-optic waveguide to scan over the ROI. As an alternative, the entire FOV can be scanned by the scanning element, and the illuminator can vary its behavior when each of the ROIs is traversed. In an example, the detection circuitry 124 can include circuitry for digitizing the received image.

In an example, the LIDAR system 100 can be installed in an automobile, such as to facilitate an autonomous self-driving automobile. An FOV of the optical system 116 can be associated with the photosensitive detector 120, such as in which the optical system 116 images light onto the photosensitive detector 120. The photosensitive detector 120 can include and be divided into an array of detector pixels 121, and the optical system's field of view (FOV) can be divided into an array of pixel FOVs with each pixel FOV of the optical system corresponding to a pixel of the photosensitive detector 120.

Increasing optical energy output per area of FOV can increase a maximum detection range of the system. For objects at longer range, the SNR generally decreases due to the diffuse reflectance nature of most materials, but the SNR can be restored by outputting more optical energy. Thus, a minimum detectable SNR can be maintained at a longer range by increasing the outputted optical energy. Optical energy can be increased by increasing pulse density, widening pulse width, and/or increasing pulse intensity.

Using various techniques of this disclosure and as described in more detail below, the LIDAR system can adjust one or more parameters to vary the illumination output within at least one of the ROIs 126 in the FOV 112 and to adjust one or more corresponding parameter(s) in the receiver circuitry 114. For example, the illuminator 105 can transmit a first light pulse having a light pulse parameter towards a first one of the ROIs 126, e.g., ROI 126A within the FOV 112. The control circuitry can modify one or more light pulse parameters, e.g., pulse width, and the illuminator 105 can transmit a second light pulse having the modified light pulse parameter(s), e.g., a modified pulse width, towards a second one of the ROIs 126, e.g., ROI 126B. In response to modifying the light pulse parameter(s), e.g., pulse width, the control circuit can modify a parameter, e.g., a bandwidth, in a receiver circuit of the system, e.g., the detection circuitry 124.

In this manner, various techniques of this disclosure can vary the illumination based on a region that is being scanned. This can allow an adaptive FOV while still maintaining a fixed scan pattern. As such, these techniques can be applicable to liquid crystal waveguides, rotating mirrors, and micro-electro-mechanical systems (MEMS) mirrors.

The illumination varying techniques of this disclosure can be used in combination with various techniques described in U.S. patent application, filed even date herewith, titled OPTICAL PULSE CODING IN A LIDAR TRANSMITTER (Attorney Docket No. 3867.576US1, Client Docket No. APD 6667), naming Ronald A. Kapusta, Shaun S. Kuo, and Miles R. Bennett as inventors, the disclosure of which is hereby incorporated herein by reference, in its entirety, including its disclosure of generating a light pulse for transmission that has an optical intensity profile that includes a waveform having one or more relatively narrower pulses superimposed upon a relatively wider pulse.

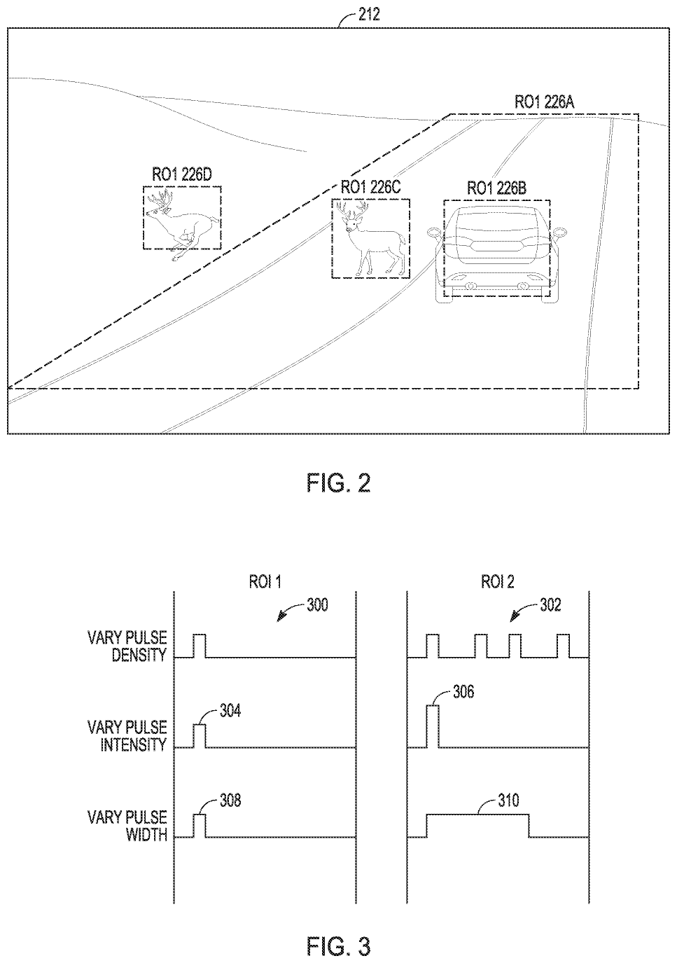

FIG. 2 is a conceptual diagram depicting an example of a field-of-view with multiple regions-of-interest. The entire diagram 200 can represent an FOV 212. Within the FOV 212, four (4) ROIs are shown, namely ROIs 226A-226D. There could be more ROIs or fewer ROIs than the four shown. The diagram 200 can represent a non-limiting example of an automotive LIDAR application that can utilize the adaptive FOV techniques of this disclosure.

The ROI 226A can generally represent the road in front of a vehicle on which the LIDAR system is affixed. The ROI 226B can represent a first object, e.g., another vehicle, in front of the vehicle. The ROIs 226C, 226D can represent second and third objects, e.g., deer, on or near the roadway on which the vehicle is travelling.

In some LIDAR applications, e.g., facial recognition, there can be areas of particular interest where it may be useful to adjust illumination parameters dynamically. In an automotive application, there may be only a small region over which truly long range is needed (e.g., the road being traveled), but the location of the region can move throughout the FOV based on road curvature, vehicle movement, etc. By varying the illumination properties between regions of interest within an FOV, an optical budget (e.g., power, energy, and thermal load) of the LIDAR system can be efficiently utilized to achieve long range detection only where it is needed, for example. Similarly, a shorter detection range can be traded off with improved distance resolution by using shorter pulses with a higher bandwidth. Distance accuracy and resolution are often more critical for objects at shorter range, for example to accurately follow traffic at a fixed distance or to perform an automated parking maneuver.

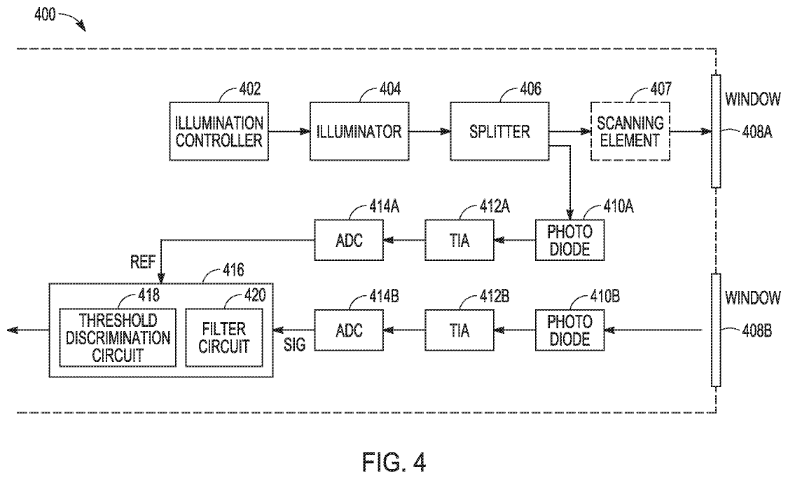

As a non-limiting example implementation and referring to FIG. 2, it may be desirable to transmit pulses having first pulse parameters to ROI 226A within the FOV 212, for example, and to transmit pulses having different second pulse parameters to ROI 226B within the FOV. In response to modifying the pulse parameters, a control circuit can modify a parameter, e.g., a bandwidth, in a receiver circuit of the system, e.g., the detection circuitry 124 of FIG. 1 or the pulse detector circuit 416 of FIGS. 4-6.

FIG. 3 is a conceptual diagram depicting examples of various light pulse parameters that can be adjusted between regions-of-interest in a field-of-view using various techniques of this disclosure. As seen in FIG. 3, the pulse density, the pulse intensity, and the pulse width can be varied between two ROIs within an FOV, e.g., ROI 1 and ROI 2. The pulse density can have a first pulse density 300 for scanning a first ROI, e.g., ROI 226A of FIG. 2, and have a second pulse density 302, e.g., increased pulse density, for scanning a second ROI, e.g., ROI 226B of FIG. 2.

In another example implementation, the pulse intensity can have a first pulse intensity 304 for scanning the first ROI, e.g., ROI 226A of FIG. 2, and have a second pulse intensity 306, e.g., increased pulse intensity, for scanning the second ROI, e.g., ROI 226B of FIG. 2.

In another example implementation, the pulse width can have a first pulse width 308 for scanning the first ROI, e.g., ROI 226A of FIG. 2, and have a second pulse width 310, e.g., increased pulse width, for scanning the second ROI, e.g., ROI 226B of FIG. 2.

In response to modifying the pulse parameter(s), e.g., density, intensity, and/or width, a control circuit can modify one or more parameters in a receiver circuit of the system. For example, as described in more detail below, the receiver circuit of the LIDAR system can modify a bandwidth parameter in response to a change in a pulse width of the transmitted light. As another example, the receiver circuit of the LIDAR system can modify a threshold discrimination parameter in response to a change in a pulse intensity of the transmitted light. As another example, the receiver circuit of the LIDAR system can modify a filter parameter in response to a change in a pulse density of the transmitted light.

Although not depicted in FIG. 3, in addition to pulse width, pulse intensity, and pulse density, the control circuit can modify a frequency, a duty cycle, and a dwell time.

FIG. 4 illustrates an example of a system architecture 400 and corresponding signal flow, such as for implementing a LIDAR system in accordance with various techniques of this disclosure. The LIDAR system 400 can be a pulsed illumination LIDAR system or a continuous wave LIDAR system.

In the example of FIG. 4, an illumination controller 402 (or control circuit, such as control circuit 104 of FIG. 1) can be coupled to an illuminator circuit 404 and can control the illumination output of the illuminator circuit 404. The illuminator circuit 404 can be coupled to a splitter circuit 406, such as to direct pulses of light to a first window 408A and to a detector or detector array, such as including a photodiode 410A. The splitter circuit 406 is shown as a separate element in FIG. 4 but in some configurations can be combined with the illuminator circuit 404 and can be a feature of other elements, such as reflection from the transmit window 408A.

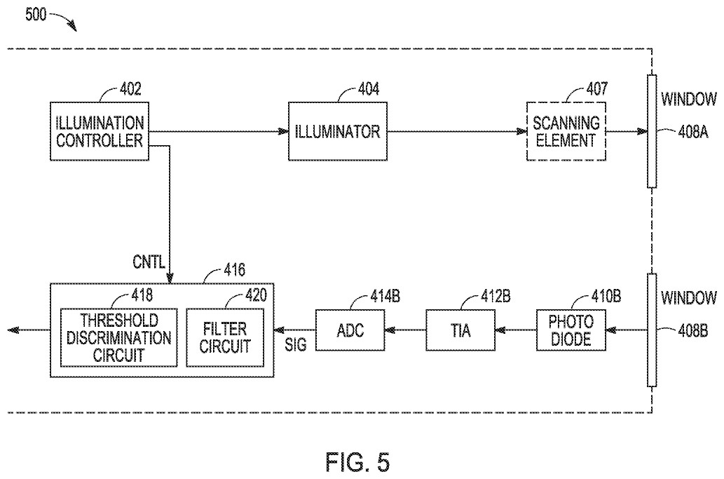

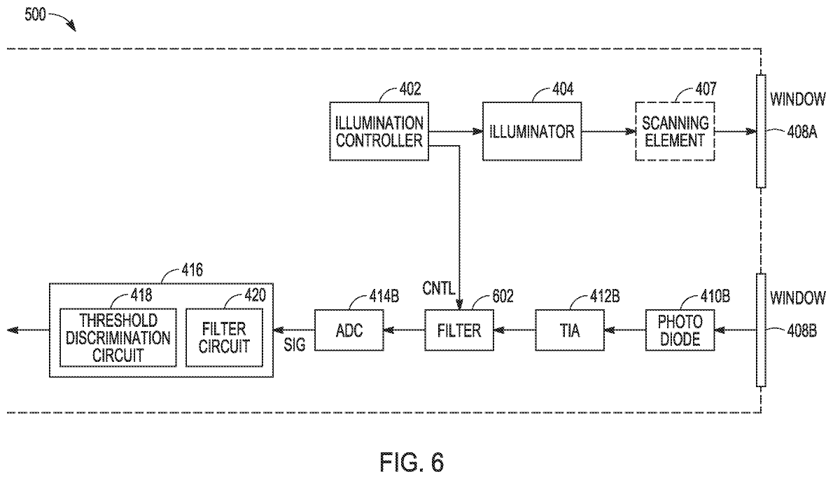

Optionally, the system architecture 400 can include a scanning element 407, as shown in FIG. 4. The system architectures 500 and 600 of FIGS. 5 and 6, respectively, can also optionally include a scanning element 407. In some example implementations, the scanning element 407 can be similar to the scanning element 106 of FIG. 1. The scanning element 407 can allow the system to scan through different ROIs, e.g., ROIs 126A-126C of FIG. 1.

In flash systems that do not include the optional scanning element 407, a common illumination can be applied to the entire FOV, but different receiver parameters can be applied to ROIs within the FOV. For example, an ROI in the center of the FOV can use a low receiver bandwidth to detect objects at long range, whereas the ROIs toward the edges of the FOV can use a high bandwidth to detect close in objects, such as cars in adjacent lanes, with high distance resolution and accuracy. With a flash system, the variation in the illumination parameter(s) can occur over time, e.g., flash the entire FOV multiple times with different illumination parameters each time.

The photodiode 410A can provide an electrical signal representative of a light pulse generated by the illuminator circuit 404 to a signal chain including a transimpedance amplifier (TIA) circuit 412A and an analog-to-digital converter (ADC) circuit 414A to provide a digital representation reference signal REF of the light pulse. The digital representation reference signal REF can be used as a reference waveform for use in pulse detection. For example, a pulse detection circuit 416 can receive the digital signal REF and can search a received signal SIG to find a signal corresponding to the digital representation REF, e.g., using a matched filter. Therefore, the digital signal REF can be used to adjust the filter coefficients for circuit 420.

Light scattered or reflected by a target in an FOV in response to a light pulse from the illuminator circuit 404 can be received through a second window 408B, such as through a signal chain similar to the reference waveform signal chain. For example, the received light can be detected by a photodiode 410B, and a signal representative of the received light can be amplified by a TIA 412B and digitized by an ADC circuit 414B.

In an example implementation, the signal chains defined by the TIAs 412A and 412B, along with photodiodes 410A and 410B, and ADCs 414A and 414B can be matched. For example, one or more of gain factor, offset, bandwidth, delay, filtering, and ADC timing can be matched between the two signal chains to facilitate use of the pulse detection circuit 416 to detect scattered or reflected light pulses from the target using the locally-generated representation of the reference waveform.

The pulse detection circuit 416 can include various components that can implement one or more detection techniques amongst a variety of detection techniques. For example, the pulse detection circuit 416 can include a threshold discrimination circuit 418 and/or a filter circuit 420. The threshold discrimination circuit 418 can be configured to determine whether a pulse has been received in response to a transmitted light pulse. If an intensity equals or exceeds a threshold of the threshold discrimination circuit 418, then the threshold discrimination circuit 418 can determine that a light pulse was received.

The filter circuit 420 can be configured to filter the received signal using one or more time domain coefficients and/or frequency domain coefficients applied to a mathematical operation.

Using various techniques of this disclosure, the illumination controller 402 can adjust one or more parameters to modify the illumination output of the illuminator circuit 404 of the system 400 and thus vary the illumination within at least one of the ROIs in the FOV. For example, the illumination controller 402 can adjust one or more of pulse width, pulse intensity, pulse density, frequency, duty cycle, and dwell time of a pulse.

In response to modifying the light pulse parameter(s), e.g., pulse width, intensity, etc., the illumination controller 402 can modify one or more parameters, e.g., a bandwidth, in a receiver circuit of the system, e.g., the pulse detection circuit 416. For example, the pulse detection circuit 416 can modify one or more parameters of the filter circuit 420, e.g., time and/or frequency domain coefficients, to modify the filter circuit 420, e.g., to adjust the bandwidth.

In some examples, the illumination controller 402 can increase a signal width and, in response, the pulse detection circuit 416 can decrease a bandwidth of a filter circuit 420. Such a configuration can increase the maximum transmission range and decrease noise in the detection circuit. In other examples, the illumination controller 402 can decrease a signal width and, in response, the pulse detection circuit 416 can increase a bandwidth of a filter circuit 420. Such a configuration can improve range resolution and accuracy. Range (or distance) can be determined based on time-of-flight. Shorter, sharper pulses can lead to less time uncertainty and, as such, improve range estimation accuracy. Also, in the event of multiple reflections from multiple targets, shorter pulses are less likely to overlap in time and, as such, improve range resolution, or the minimum distance between two objects for which they can be discriminated.

In the example implementation shown in FIG. 4, modifying a bandwidth of the detection circuit occurs after digitizing the received signal SIG. In other implementations, such as shown in FIG. 6, the bandwidth of the detection circuit can be adjusted prior to digitizing a received signal.

In some example implementations, the filter circuit 420 can include a matched filter with coefficients that can be adjusted, such as adaptively, to approximate the profile of the transmitted light pulse in response to the illumination controller 402 modifying the light pulse parameter. The pulse detection circuit 416 can receive the REF signal and the filter circuit 420 can then apply a matched filter to the temporal profile of the received light signal SIG. For example, the illumination controller 402 can modify a pulse pattern, such as changing a pulse density, and, in response, the pulse detection circuit can modify a parameter of the filter circuit, e.g., a filter coefficient, to approximate the modified signal pattern. Increasing a pulse density along with randomizing a timing between pulses can be used to uniquely identify a transmitted pulse stream, which can be used to disambiguate the pulse stream from other sources, such as interfering LIDAR systems.

In another example, a threshold detection scheme can be used, such as having an adjustable threshold. In response to the illumination controller 402 modifying the light pulse parameter, e.g., intensity, the threshold discrimination circuit 418 can adjust its threshold accordingly.

Although described in this disclosure with respect to light pulses, the techniques of this disclosure are not limited to pulsed illumination LIDAR systems and light pulses specifically. Rather, the techniques described can also be applied to continuous wave (CW) LIDAR systems and, as such, can be considered applicable to light signals generally, which include light emitted from both pulsed illumination LIDAR systems and continuous wave LIDAR systems.

The illumination controller 402 can vary the illumination output by the illuminator circuit 404 in various ways. If a pulsed laser diode is used, the electrical drive waveform applied to the laser diode can be varied. The laser diode converts an electrical current to an optical output. Driving the laser diode with a different current waveform can directly modulate the optical output. For example, to increase pulse intensity, a voltage supplied to the laser driver can be increased to increase the current supplied to the laser diode. As another example, to increase pulse density, the laser driver can be triggered more frequently.

If a passively Q-switched pulsed laser is used, an electrical pump current can be varied. Varying the pump current can vary a firing rate of the laser and thus vary the pulse density. If an actively Q-switched pulsed laser is used, a timing of an active control element can be varied. Varying the Q-switch timing can vary both a laser firing rate and a pulse energy.

If a continuous wave laser is used, e.g., in a frequency-modulated continuous-wave LIDAR system, an electrical drive signal applied to the laser diode can be varied in intensity over time. Varying the drive signal amplitude can vary an output intensity. Varying the drive signal amplitude can also vary an output frequency (resulting in a chirp). Varying a timing of a waveform of varying amplitude can change chirp bandwidth and chirp length. Alternatively, a constant drive signal can be applied to the laser diode, and the frequency modulation can be performed by another optical circuit, such as an electro-optic or acousto-optic modulator. In these cases, varying the amplitude and timing of the waveform applied to the modulator can change the chirp bandwidth and chirp length.

In some example LIDAR configurations, the illumination controller 402 can directly adjust the pulse detection circuit, such as shown in FIG. 5.

FIG. 5 illustrates another example of a system architecture 500 and corresponding signal flow, such as for implementing a LIDAR system in accordance with various techniques of this disclosure. The LIDAR system 500 can be a pulsed illumination LIDAR system or a continuous wave LIDAR system. The LIDAR system of FIG. 5 can include components similar to those shown in FIG. 4, with like elements indicated by like reference numerals.

As seen in FIG. 5, the illumination controller 402 can directly adjust the pulse detection circuit 416 using a control signal CNTL. As such, the system 500 does not need a splitter circuit, photo diode, TIA, and ADC in a reference path, as in FIG. 4.

For example, the illumination controller 402 can control the illuminator circuit 404 to increase a pulse width and can send the CNTL signal to the pulse detection circuit 416 that instructs the pulse detection circuit 416 to monitor for a received signal having a wide pulse and to decrease the bandwidth of the filter circuit 420, for example.

In some example LIDAR configurations, any bandwidth adjustment can be performed in the analog domain prior to digitization, such as shown in FIG. 6. For example, the feedback capacitor on TIA could be changed dynamically.

FIG. 6 illustrates another example of a system architecture 600 and corresponding signal flow, such as for implementing a LIDAR system in accordance with various techniques of this disclosure. The LIDAR system 600 can be a pulsed illumination LIDAR system or a continuous wave LIDAR system. The LIDAR system of FIG. 6 can include components similar to those shown in FIG. 4, with like elements indicated by like reference numerals.

As seen in FIG. 6, the illumination controller 402 can be coupled to an analog filter circuit 602 in the receiver signal chain that is upstream of the ADC circuit 414B. In this manner, the illumination controller 402 can directly adjust the analog filter circuit 602 using a control signal CNTL.

For example, the illumination controller 402 can control the illuminator circuit 404 to increase a pulse width and can send the CNTL signal to the filter circuit 602 to control the filter circuit 602 to decrease the bandwidth of the filter circuit in response to the increased pulse width, for example.

In some example implementations, it can be desirable to adjust one or more parameters of the ADC 414B in FIGS. 4-6. For example, the sampling rate of the ADC 414B can be adjusted, e.g., a wide pulse can allow a lower sample rate. In other examples, one or more parameters of the ADC 414B can be adjusted to change, e.g., lower, a noise floor so as to detect small signals from long-range.

By using various techniques described above, the optical budget of a LIDAR system can be utilized more efficiently. An adaptive FOV can be generated by varying the illumination properties of the transmitter circuit of the LIDAR system between two or more ROIs within an FOV and adjusting one or more corresponding receive parameter(s).

### Notes

Each of the non-limiting aspects or examples described herein may stand on its own or may be combined in various permutations or combinations with one or more of the other examples.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of“at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact discs and digital video discs), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

The claimed invention is:

1. A method for varying illumination between two or more regions-of-interest (ROI) within a field-of-view (FOV) using a light detection and ranging (LIDAR) system, the method comprising:
transmitting a first light signal having a light signal parameter towards a first one of the ROIs;
modifying the light signal parameter;
transmitting a second light signal having the modified light signal parameter towards a second one of the ROIs; and
modifying a parameter in a receiver circuit of the system in response to modifying the light signal parameter.

2. The method of claim 1, wherein modifying the parameter in the receiver circuit of the system in response to modifying the light signal parameter includes modifying a bandwidth of a detection circuit.

3. The method of claim 2, wherein the light signal parameter includes a width, and wherein modifying the light signal parameter includes modifying the width of the first light signal.

4. The method of claim 1, wherein the light signal parameter includes a signal intensity, wherein modifying the light signal parameter includes modifying the signal intensity of the first light signal, and wherein modifying a parameter in a receiver circuit of the system in response to modifying the light signal parameter includes modifying a receiver detection threshold of a detection circuit.

5. The method of claim 1, wherein modifying the light signal parameter includes modifying one or more of a width, a density, a frequency, a duty cycle, a dwell time, and an intensity of the first light signal.

6. The method of claim 1, wherein modifying the light signal parameter includes increasing a signal width, and wherein modifying the parameter in the receiver circuit of the system in response to modifying the light signal parameter includes decreasing a bandwidth of a detection circuit.

7. The method of claim 1, wherein modifying the light signal parameter includes decreasing a signal width, and wherein modifying the parameter in the receiver circuit of the system in response to modifying the light signal parameter includes increasing a bandwidth of a detection circuit.

8. The method of claim 1, wherein modifying the parameter in the receiver circuit of the system in response to modifying the light signal parameter includes modifying a bandwidth of a detection circuit prior to digitizing a received signal.

9. The method of claim 1, wherein modifying the parameter in the receiver circuit of the system in response to modifying the light signal parameter includes modifying a filter parameter of a detection circuit.

10. The method of claim 9, wherein modifying the light signal parameter includes modifying a signal pattern, and wherein modifying the filter parameter of the detection circuit includes modifying the filter parameter to approximate the modified signal pattern.

11. A light detection and ranging (LIDAR) system configured to vary illumination between two or more regions-of-interest (ROI) within a field-of-view (FOV), the system comprising:
a transmitter circuit configured to transmit a first light signal having a light signal parameter towards a first one of the ROIs;
a control circuit configured to modify the light signal parameter and control the transmitter circuit to transmit a second light signal having the modified light signal parameter towards a second one of the ROIs; and
a receiver circuit configured to receive reflected light from the second one of the ROIs and modify a parameter in the receiver circuit in response to the modified light signal parameter.

12. The system of claim 11, wherein the receiver circuit includes a detection circuit, and wherein the receiver circuit configured to modify the parameter in the receiver circuit in response to the modified light signal parameter is configured to modify a bandwidth of the detection circuit.

13. The system of claim 12, wherein the light signal parameter includes a width, and wherein the control circuit configured to modify the light signal parameter is configured to modify the width of the first light signal.

14. The system of claim 11, wherein the light signal parameter includes a signal intensity, wherein the control circuit configured to modify the light signal parameter includes is configured to modify the signal intensity of the first light signal,
wherein the receiver circuit includes a detection circuit, and
wherein the receiver circuit configured to modify the parameter in the receiver circuit in response to the modified light signal parameter is configured to modify a receiver detection threshold of the detection circuit.

15. The system of claim 11, wherein the receiver circuit includes an analog filter circuit, and wherein the control circuit is coupled to the analog filter circuit.

16. The system of claim 11, wherein the receiver circuit includes a detection circuit, and wherein the control circuit is directly coupled to the detection circuit.

17. The system of claim 11, wherein the receiver circuit includes a detection circuit having a filter circuit, and wherein the control circuit is configured to modify a filter parameter of the filter circuit.

18. The system of claim 11, wherein the receiver circuit includes a detection circuit having a threshold discrimination circuit, and wherein the control circuit is configured to modify a threshold of the threshold discrimination circuit.

19. A light detection and ranging (LIDAR) system configured to vary illumination between two or more regions-of-interest (ROI) within a field-of-view (FOV), the system comprising:
means for transmitting a first light signal having a light signal parameter towards a first one of the ROIs;
means for modifying the light signal parameter;
means for transmitting a second light signal having the modified light signal parameter towards a second one of the ROIs; and
means for modifying a parameter in a receiver circuit of the system in response to modifying the light signal parameter.

20. The system of claim 19, wherein the means for modifying the parameter in the receiver circuit of the system in response to modifying the light signal parameter includes means for modifying a bandwidth of a detection circuit.
